(19) United States
(12) Patent Application Publication
(10) Pub. No.: US 2017/0168756 A1
(43) Pub. Date: Jun. 15, 2017

(54) STORAGE TRANSACTIONS

(71) Applicant: HEWLETT PACKARD ENTERPRISE DEVELOPMENT LP, Huston, TX (US)

(72) Inventors: Kouei Yamada, Fremont, CA (US); Siamak Nazari, Fremont, CA (US); Brian Rutledge, Belfast (GB); Jianding Luo, Fremont, CA (US); Jin Wang, Fremont, CA (US); Mark Doherty, Belfast (GB); Richard Dalzell, Belfast (GB); Peter Hynes, Dundrum (GB)

(21) Appl. No.: 15/325,774

(22) PCT Filed: Jul. 29, 2014
(86) PCT No.: PCT/US2014/048673

§ 371 Date: Jan. 12, 2017

(51) Int. Cl. G06F 3/06

(52) U.S. Cl. CPC G06F 3/0659; G06F 3/0619; G06F 3/067

(57) ABSTRACT

A system that includes a plurality of nodes configured to execute storage transactions. The nodes include a first node and a plurality of other nodes. The storage transactions are grouped into transaction sets that are to be executed in a predetermined order that ensures that dependencies between the transactions are observed. A cluster sequencer that resides on the first node is configured to increment a sequence number that identifies an active transaction set of the transaction sets and send the sequence number from the first node to the plurality of other nodes. Upon receipt of the sequence number, each one of the plurality of other nodes begins executing the transactions of the active transaction set without waiting for confirmation that all of the plurality of other nodes have the same sequence number.

### BACKGROUND

Many large-scale storage systems are configured as highly-available, distributed storage systems. Such storage systems incorporate a high level of redundancy to improve the availability and accessibility of stored data. For example, a clustered storage system can include a network of controller nodes that control a number of storage devices. A large number of nodes can be configured to have access to the same storage devices, and the nodes themselves can also be communicatively coupled to each another for internode communications. This configuration enables load balancing between the nodes and failover capabilities in the event that a node fails.

### BRIEF DESCRIPTION OF THE DRAWINGS

Certain exemplary embodiments are described in the following detailed description and in reference to the drawings, in which:

FIG. 1 is an example block diagram of a computer system with a cluster sequencer;

FIG. 2 is an example process flow diagram of a method of processing transaction is a computer system with a cluster sequencer;

FIG. 3 is an example block diagram of the computer system showing cluster sequencer failover; and

FIG. 4 is an example block diagram of the computer system showing multiple cluster sequencers; and

FIG. 5 is an example block diagram showing a tangible, non-transitory, computer-readable medium that stores code configured to operate one or more nodes of a computer system with a cluster sequencer.

### DETAILED DESCRIPTION OF SPECIFIC EMBODIMENTS

The present disclosure provides techniques for synchronizing Input/Output (I/O) transactions in a computer system. Transaction synchronization helps to ensure that transactions occur in the proper order. For example, in an asynchronous storage replication system, the replicated storage transactions are to be processed in the same order that the original storage transactions occurred. Otherwise, misalignment of the storage transactions can occur, in which case the replicated state may not accurately represent the original state of the replicated storage system.

In a computer system with multiple storage controllers, also referred to herein as nodes, two or more nodes may have access to the same storage space. In a multiple-node system, misalignment of transactions can occur when nodes operate slightly out of sync or access shared data at different points in time. In some systems, I/O transactions are synchronized through the use of synchronization information that is broadcast globally to all nodes in the system. Each node acknowledges receipt of the synchronization information. After all nodes acknowledge receipt of the synchronization information, each node can then be instructed to proceed with the processing of transactions. This process can be inefficient and error prone because it relies on each node acknowledging the receipt of the new synchronization information before processing of transaction can proceed.

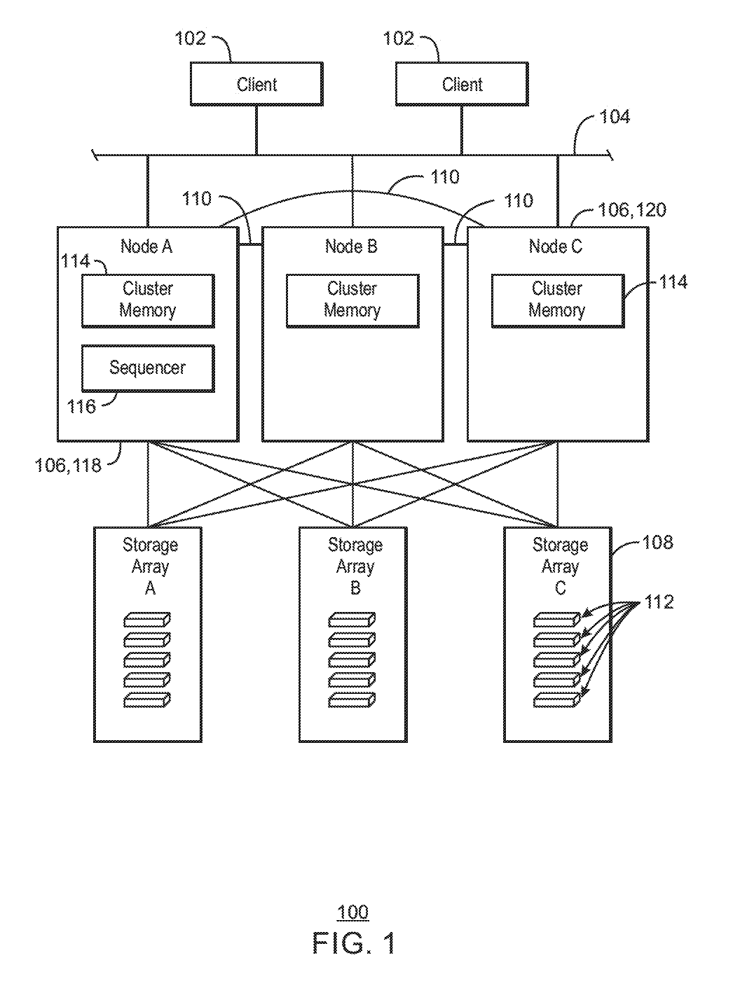

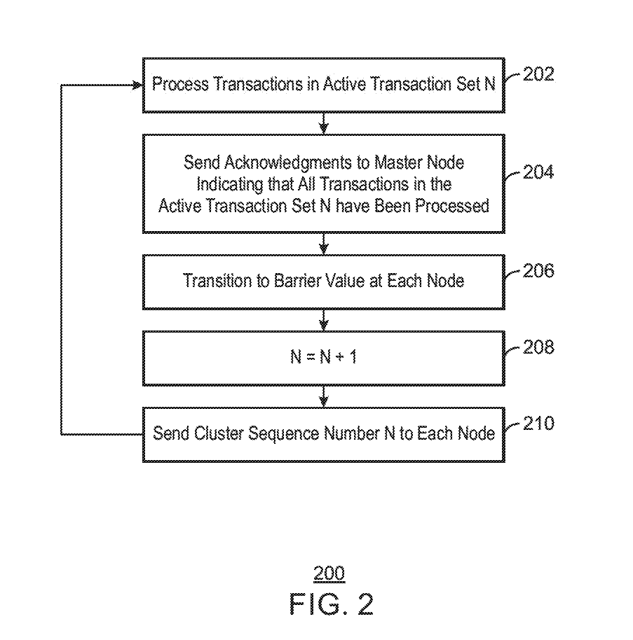

In examples of the present techniques, sequence information is transmitted to nodes in the form of a cluster sequence number. The cluster sequence number is a sequentially increasing value that is written to each node by a programmable timer within a master node. In between transitions of the cluster sequence number, the cluster sequence number transitions to a barrier value, which serves to block transaction processing during the sequence number update. This ensures that no two nodes in the system will ever have conflicting sequence numbers. Accordingly, transactions can be synchronized across multiple nodes without requiring the nodes to acknowledge the receipt of the new synchronization information. Examples of the sequencing system are described more fully below in relation to FIGS. 1 and 2.

FIG. 1 is an example block diagram of a computer system with a cluster sequencer. It will be appreciated that the computer system 100 shown in FIG. 1 is only one example of a computer system in accordance with embodiments. In an actual implementation, the computer system 100 may include various additional storage devices and networks, which may be interconnected in any suitable fashion, depending on the design considerations of a particular implementation. For example, a large computer system will often have many more client computers and storage devices than shown in this illustration.

The computer system 100 provides data storage resources to any number of client computers 102, which may be general purpose computers, workstations, mobile computing devices, and the like. The client computers 102 can be coupled to the computer system 100 through a network 104, which may be a local area network (LAN), wide area network (WAN), a storage area network (SAN), or other suitable type of network. The computer system 100 includes storage controllers, referred to herein as nodes 106. The computer system 100 also includes storage arrays 108, which are controlled by the nodes 106. The nodes 106 may be collectively referred to as a computer cluster. For the sake of simplicity, only three nodes are shown. However, it will be appreciated that the computer cluster can include any suitable number of nodes, including 2, 4, 6, 10, or more.

The client computers 102 can access the storage space of the storage arrays 108 by sending Input/Output (I/O) requests, including write requests and read requests, to the nodes 106. The nodes 106 process the I/O requests so that user data is written to or read from the appropriate storage locations in the storage arrays 108. As used herein, the term “user data” refers to data that a person might use in the course of business, performing a job function, or for personal use, such as business data and reports, Web pages, user files, image files, video files, audio files, software applications, or any other similar type of data that that a user may wish to save to storage. Each of the nodes 106 can be communicatively coupled to each of the storage arrays 108. Each node 106 can also be communicatively coupled to each other node by an inter-node communication network 110.

The storage arrays 108 may include any suitable type of storage devices, referred to herein as drives 112. For examples, the drives 112 may be solid state drives such as flash drives, hard disk drives, and tape drives, among others. Furthermore, the computer system 100 can include more than one type of storage component. For example, one storage array 108 may be an array of hard disk drives, and another storage array 108 may be an array of flash drives. In some examples, one or more storage arrays may have a mix of different types of storage. The computer system 100 may also include additional storage devices in addition to what is shown in FIG. 1.

Each client computer 102 may be coupled to a plurality of the nodes 106. One or more logical storage volume may be provisioned from the available storage space of one or a combination of storage drives 112 included in the storage arrays 108. In some examples, each volume may be further divided in regions, and each node 106 is configured to controls a specific region and is referred to herein as the owner for that region.

Requests by the client computers 102 to access storage space are referred to herein as transactions. Examples of types of transactions include write operations, read operations, storage volume metadata operations, and reservation requests, among others. In some examples, the client computer 102 is a remote client and the transactions are for remote replication of data. Each transaction received by the computer system 100 includes dependency information that identifies the ordering in which transactions are to be processed.

Each node 106 may include its own separate cluster memory 114, which is used to cache data and information transferred to other nodes 106 in the computer system 100, including transaction information, log information, and inter-node communications, among other information. The cluster memory can be implemented as any suitable cache memory, for example, synchronous dynamic random access memory (SDRAM). One or more of the nodes 106 also includes a cluster sequencer 116.

To further help synchronize transactions, the transactions can be grouped into transaction sets. Each transaction set can include any suitable number of transactions, including tens or hundreds of transactions. Each transaction received by the computer system 100 can include information that identifies the transaction set that the transaction belongs to and the dependencies between the transaction sets, i.e., the order in which the transaction sets are to be processed. For example, each transaction may include a sequence number that identifies the transaction set and the relative order in which transaction sets are to be processed.

Transaction sets can be defined by the client application that generates the transactions. For example, in the case a remote data replication application, the transaction sets are defined by the remote system from which the transactions are received. The computer system 100 is configured to process one transaction set at a time and in the order specified by the transaction set identifiers. In this way, the dependencies between the individual transactions of different transaction sets are observed.

To ensure that each node 106 is processing transactions of the same transaction set, the computer system 100 includes a cluster sequencer 116 that informs each node 106 which transaction set is currently being processed by the computer system 100. To inform each node 106 which transaction set is currently being processed, the cluster sequencer 116 generates an identifier, referred to herein as the cluster sequence number, to be sent to each node 106 in the computer system 100. The cluster sequence number corresponds with the sequence number associated with each transaction and is used to identify the particular transaction set currently being processed by the computer system 100. The particular transaction set currently being processed by the computer system 100 is also referred to herein as the active transaction set.

As shown in FIG. 1, the cluster sequencer 116 can reside on one of the nodes 106 of the computer system. The cluster sequencer 116 can be implemented in hardware or a combination of hardware and software. For example, the cluster sequencer 116 can be implemented as logic circuits, or computer code executed by a processor such as a general purposes processor, an Application Specific Integrated Circuit (ASIC), or any other suitable type of integrated circuit. The node 106 that operates the cluster sequencer is referred to herein as the master node 118. Nodes 106 other than the master node 118 may be referred to as slave nodes 120. Although a single cluster sequencer is shown in FIG. 1, the computer system can include two or more cluster sequencers 116, wherein each cluster sequencer 116 is used by separate applications that do not need to observe dependencies between one another. Furthermore, each of the nodes 106 can be configured to operate the cluster sequencer 116. If the master node 118 fails, the cluster sequencer 116 can failover to another one of the nodes 106, which then becomes the new master node 116.

The master node 118 can send the cluster sequence number to each of the slave nodes 120 through the inter-node communication network 110 using any suitable communication protocol. In some examples, the master node 118 can send the cluster sequence number to the slave nodes 120 by writing to a shared portion of the cluster memory 114 of each slave node 120. The cluster sequence number can be stored at one or more memory locations in each node 106, including the cluster memory 114 and processor memory.

Upon receipt of the cluster sequence number, the slave node 120 can begin processing transactions of the active transaction set without waiting for any further communications from the master node 118. The receipt of the cluster sequence number serves to identify the active transaction set to be processed and also permits the processing of the transaction set to begin. The slave node 120 does not need to send an acknowledgement to the master node 118 after receiving the cluster sequence number, or wait for further confirmation from the master node 118 to begin processing the active transaction set.

In some examples, the cluster sequencer 116 increments the cluster sequence number at regular intervals. The time interval between increments can be set by the application and determined at an initialization stage. To ensure that each transaction set finishes processing, the master node 118 may wait for an acknowledgment from each slave node 120 that indicates that the particular node is finished processing the transactions of the current transaction set before incrementing the cluster sequence number.

If two nodes 106 were allowed to process two different transaction sets at the same time, the result could be a violation of the dependencies between individual transactions. To ensure that the nodes 106 cannot process different transaction sets at the same time, the cluster sequencer 116 ensures that no two nodes will see different cluster sequence numbers. To do this, each increment of the cluster sequence number to the next transaction set begins by transitioning the cluster sequence number from the active transaction set to a barrier value, such as −1. The barrier value is a value that blocks the nodes 106 from processing transactions and does not correspond to an actual transaction set identifier. After the master node 118 has sent the barrier value to all of the nodes 106, the master node 118 can then begin sending the next cluster sequence number to each of the slave nodes 120. As the cluster sequence numbers are sent to the slave nodes 120, different slave nodes 120 may have different cluster sequence values. For example, some nodes 106 may have a cluster sequence number that identifies the current transaction set, while at the same time other nodes will have the barrier value. However, due to the barrier transition, no two nodes will have cluster sequence numbers that identify different transaction sets at the same time.

FIG. 2 is an example process flow diagram of a method of processing transactions is a computer system with a cluster sequencer. The method 200 can be performed by one or more computing devices such as the nodes 106 of the computer system 100 shown in FIG. 1.

At block 202, the computer system 100 is in actively processing a transaction set N, where N represents the number of the active sequence. At each of the nodes 106, the cluster sequence number has been set to the active sequence N, and each node 106 is processing transactions that have the sequence identifier that corresponds with N.

At block 204, each of the slave nodes 120 sends an acknowledgment to the master node 118 to indicate that that all of the transactions for the active sequence have been processed. Each slave node 120 individually sends its acknowledgement after the transactions under its control for the active sequence have finished processing. The acknowledgements can be sent to master node 118 via the inter-node communication network 110.

At block 206, the master node 118 causes each slave node to transition to the barrier value. In some examples, the cluster memory 114 of each slave node 120 includes a portion of shared memory that can be written by the master node 118, and the master node 118 can write the barrier value directly to a specified address in the shared memory. In some examples, the master node 118 causes each slave node 120 to transition to the barrier value by sending a message, such as an interrupt signal, to the each of the slave nodes 120. Upon receipt of the message, each slave node 120 invalidates the current cluster sequence number by replacing the cluster sequence number with the barrier value. Once the cluster sequence number on a particular slave node 120 transitions to the barrier value, that slave node 120 will not process I/O transactions until the cluster sequence number for that slave node 120 is updated to the next valid sequence number, i.e., a non-barrier sequence number that corresponds with a transaction set.

At block 206, the master node 118 increments the sequence number on it. Applications running on the master node can then read the new sequence number and the master node can begin processing I/O transactions for the new active sequence. Applications running on slave nodes would continue to be blocked from processing transactions.

At block 208, the master node 118 sends the new sequence number to each slave node 120. In some examples, the master node 118 sends the new sequence number to by writing the new sequence number directly to a specified address in the shared portion of the cluster memory 114. In some examples, the master node 118 causes each slave node 120 to increment the sequence by sending a message, such as an interrupt signal, to the each of the slave nodes 120. Upon receipt of the message, each slave node 120 increments the cluster sequence number. When the sequence number is incremented on a particular slave node 120, the applications running on the slave node 120 are able to read the new active sequence. The process flow then returns to block 202 and the slave nodes 120 can begin processing the transactions of the corresponding transaction set.

The process flow diagram of FIG. 2 is not intended to indicate that the elements of method 200 are to be executed in any particular order, or that all of the elements of the method 200 are to be included in every case. Further, any number of additional elements not shown in FIG. 2 can be included in the method 200, depending on the details of the specific implementation.

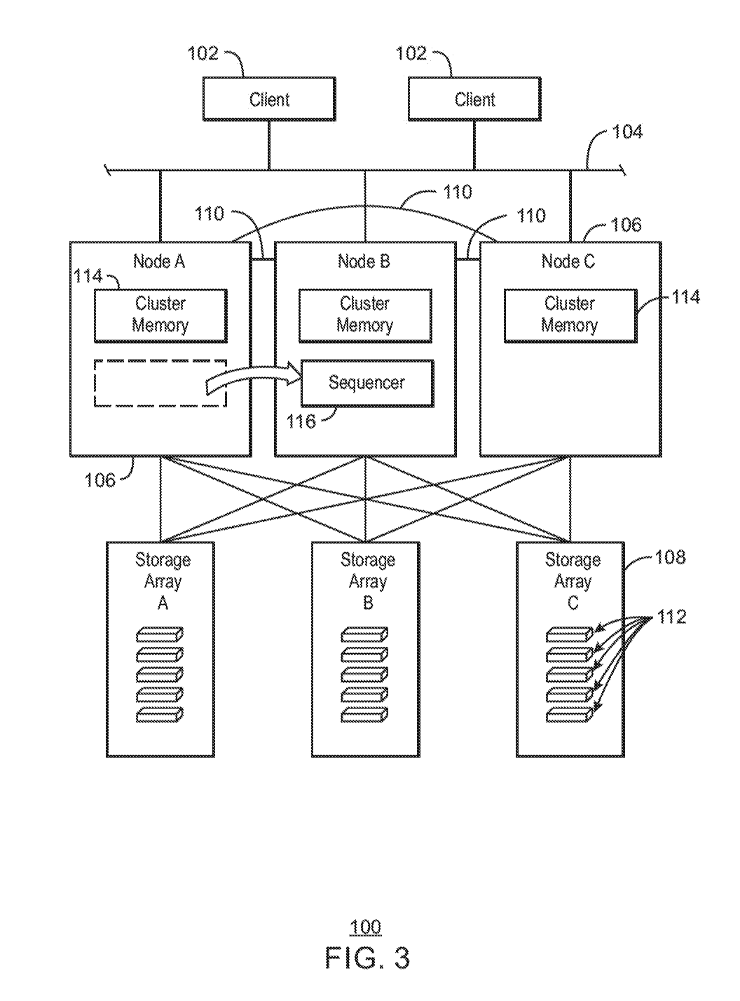

FIG. 3 is an example block diagram of the computer system showing cluster sequencer failover. Each node 106 can include the programming code used for operating a cluster sequencer. Furthermore, each node 106 can have a designated backup node that will take over the operations of the node 106 in the event that the node 106 fails. In the event of a failure of the master node operating the cluster sequencer 116, the cluster sequencer 116 can be restarted on the designated backup node.

For example, as shown in FIG. 3, node A, which had been operating as the master node, has failed. Node B, which was designated as the backup node for Node A, then becomes the master node. Node B takes over operation of the cluster sequencer 116, incrementing the sequence number, distributing sequence numbers to other nodes in the computing system, and any other duties of the master node, including those described above.

In some examples, each node 106 stores one or more the cluster sequence numbers in a memory location of the node's processor. For example, the processor memory can include the current sequence number and the previous sequence number. The previous sequence number can be used to ensure that the backup node will be able to continue operating with the correct progression of sequence numbers. When the backup node becomes the new master node, the new master node can determine the next sequence number by querying each node to identify the current and/or previous sequence number.

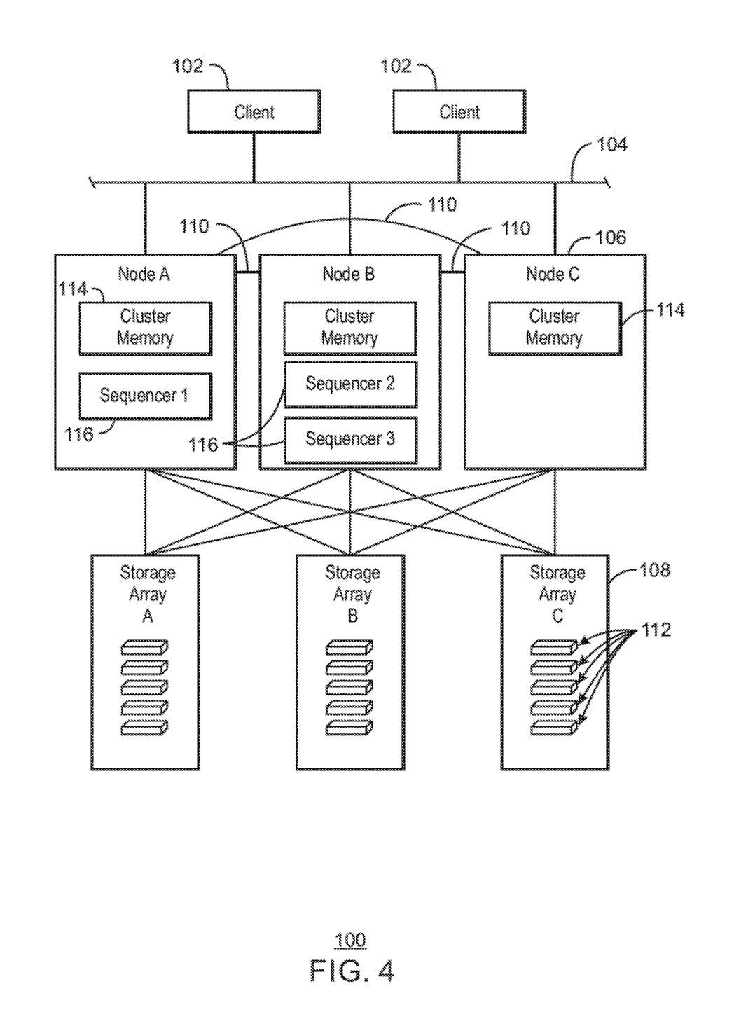

FIG. 4 is an example block diagram of the computer system showing multiple cluster sequencers. As shown in FIG. 4, the computer system 100 can be configured to operate two or more cluster sequencers 116 at the same time, labeled Sequencer 1, Sequencer 2, and Sequencer 3. Each cluster sequencer 116 is associated with a separate application (not shown), wherein the I/O transactions of each application are not dependent on one another. Each application can operate across the multiple nodes 106 of the computer system 100 using different sequences. In the example shown in FIG. 4, Node A operates as the master node for a first application that uses Sequencer 1, and Node B operates as the master node for a second application that uses Sequencer 2 and a third application that uses Sequencer 3.

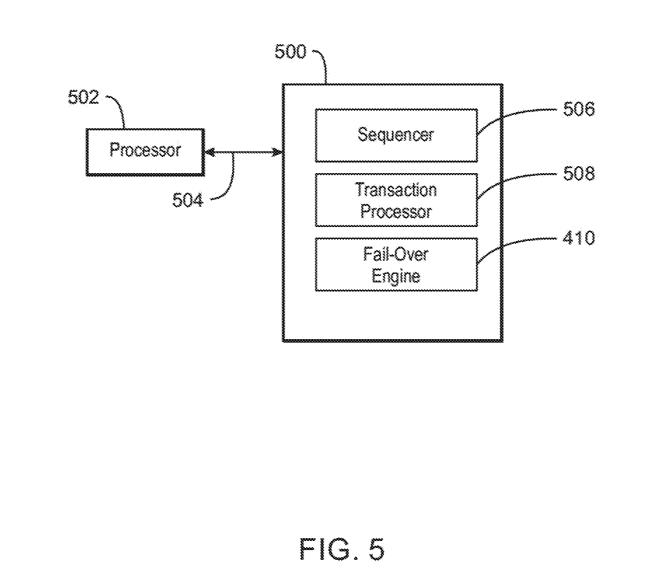

FIG. 5 is an example block diagram showing a tangible, non-transitory, computer-readable medium that stores code configured to operate one or more nodes of a computer system with a cluster sequencer. The computer-readable medium is referred to by the reference number 500. The computer-readable medium 500 can include RAM, a hard disk drive, an array of hard disk drives, an optical drive, an array of optical drives, a non-volatile memory, a flash drive, a digital versatile disk (DVD), or a compact disk (CD), among others. The computer-readable medium 500 may be accessed by a processor 502 over a computer bus 504. Furthermore, the computer-readable medium 500 may include instructions configured to direct one or more processors to perform the methods described herein. For example, the computer-readable medium 500 may include software and/or firmware that is executed by a computing device such as the nodes 106 of FIGS. 1 and 2.

The various programming code components discussed herein may be stored on the computer-readable medium 500. For example, the programming code components can be included in some or all of the processing nodes of computing system, such as the nodes 106 of computing system 100. A region 506 can include a cluster sequencer. The cluster sequencer operations are performed by the master node, but the programming code of the cluster sequencer can reside on all of the nodes 106 of the computer system 100. Multiple instances of the cluster sequencer can be launched on the same node or different nodes, wherein each instance of the cluster sequencer is used by a different application. The cluster sequencer can be configured to increment a sequence number that identifies the active transaction set and send the sequence number to a plurality of slave nodes. After receiving acknowledgements from all of slave nodes 120, the cluster sequencer can send a barrier value to each of the plurality of slave nodes. After the barrier value has been sent to all of the slave nodes, the cluster sequencer can increment the sequence number and send the incremented sequence number to the slave nodes. The cluster sequencer can be configured to increment the sequence number at a specified time interval.

A region 508 can include a transaction processor that processes storage transactions of the active transaction set. The transactions can include reading data from storage and sending the data back to a client device, and writing data to storage, among others. The transaction processor can begin executing the storage transactions of the active transaction set as soon as it receives the sequence number without waiting for confirmation that all of the slave nodes have the same sequence number. After executing all of the transactions of the active transaction set, each node can send an acknowledgement to indicate that the transactions of the active transaction set have been executed. If the slave node receives the barrier value, the slave node can invalidate the current sequence number and stop executing transactions.

A region 510 can include a fail-over engine that can detect the failure of the master node in the cluster. Upon detecting the failure of the master node, the fail-over engine of the master node's designated backup node can take over the role of the master node by performing the cluster sequencer operations previously performed by the master node. The backup node can determine the active sequence number by querying the other slave nodes.

Although shown as contiguous blocks, the programming code components can be stored in any order or configuration. For example, if the tangible, non-transitory, computer-readable medium is a hard drive, the software components can be stored in non-contiguous, or even overlapping, sectors.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the scope of the present techniques.

What is claimed is:

1. A system comprising:
a plurality of nodes to receive and execute storage transactions, the plurality of nodes comprising a first node and a plurality of other nodes, wherein the storage transactions are grouped into transaction sets that are to be executed in a predetermined order that ensures that dependencies between the transactions are observed; and
a cluster sequencer residing on the first node, the cluster sequencer to:
increment a sequence number that identifies an active transaction set of the transaction sets; and
send the sequence number from the first node to the plurality of other nodes;
wherein, upon receipt of the sequence number, each one of the plurality of other nodes begins executing the transactions of the active transaction set without waiting for confirmation that all of the plurality of other nodes have received the sequence number.

2. The system of claim 1, wherein the cluster sequencer is to send a barrier value to each of the plurality of other nodes before incrementing the sequence number; and wherein the barrier value replaces the sequence number at each of the plurality of other nodes and prevents each of the plurality of other nodes from executing transactions.

3. The system of claim 1, wherein the cluster sequencer increments the sequence number at a specified time interval.

4. The system of claim 1, wherein each of the plurality of other nodes sends an acknowledgement to the first node to indicate that the transactions of the active transaction set have been executed, and the cluster sequencer increments the sequence number after it has received the acknowledgement from all of the plurality of other nodes.

5. The system of claim 1, comprising a second cluster sequencer to perform sequencing operations for a second application.

6. The system of claim 5, wherein the second cluster sequencer resides on a second node of the plurality of other nodes.

7. The system of claim 1, wherein if the first node fails, the cluster sequencer fails over to a backup node of the plurality of other nodes.

8. A method performed by a master node and a plurality of slave nodes, comprising:
processing, at the master node and the plurality of slave nodes, storage transactions of an active transaction set identified by a sequence number;
sending a barrier value to each of the plurality of slave nodes, wherein the barrier value replaces the sequence number and prevents the slave nodes from processing the storage transactions; and
after each of the slave nodes has received the barrier value, incrementing the sequence number and sending the incremented sequence number to the slave nodes.

9. The method of claim 8, wherein upon receipt of the incremented sequence number, each of the slave nodes begins executing the transactions of the active transaction set identified by the incremented sequence number without waiting for confirmation that all of the plurality of slave nodes have received the sequence number.

10. The method of claim 8, comprising:
sending an acknowledgement from each of the slave nodes to the master node, the acknowledgement indicating that the slave node has finished processing the storage transactions of an active transaction set; and
wherein sending the barrier value to each of the plurality of slave nodes comprises sending the barrier value after receiving acknowledgements from all of the slave nodes.

11. The method of claim 8, comprising:
determining that the master node has failed; and
at a designated backup node of the slave nodes, taking over operations of the master node and querying the slave nodes to determine a most recent sequence number.

12. A tangible, non-transitory, computer-readable medium comprising instructions that direct one or more processors to:
increment a sequence number that identifies an active transaction set comprising a plurality of storage transactions;
send the sequence number to a plurality of slave nodes; and
upon receipt of the sequence number, execute the storage transactions of the active transaction set without waiting for confirmation that all of the plurality of slave nodes have received the sequence number.

13. The computer-readable medium of claim 12, comprising instructions that direct the one or more processors to:
send a barrier value to each of the plurality of slave nodes before incrementing the sequence number; and
upon receipt of the barrier value, invalidate the sequence number and stop executing transactions.

14. The computer-readable medium of claim 13, comprising instructions that direct the one or more processors to send an acknowledgement to indicate that the transactions of the active transaction set have been executed, wherein to increment the sequence number comprises to increment the cluster sequencer after receiving an acknowledgement from all of a plurality of slave nodes.

15. The computer-readable medium of claim 12, wherein to increment the sequence number comprises to increment the sequence number at a specified time interval.
